(19) United States
(12) Patent Application Publication
(10) Pub. No.: US 2003/0145702 A1
(43) Pub. Date: Aug. 7, 2003

(54) Process and device for the cutting of label sleeves

(76) Inventor: Gunther Eiban, Regensburg (DE)

Correspondence Address: MARSHALL, GERSTEIN & BORUN, 6300 SEARS TOWER, 233 SOUTH WACKER, CHICAGO, IL, 60606-6357, US

(21) Appl. No.: 10/339,046

(22) Filed: Jan. 9, 2003

(30) Foreign Application Priority Data
Feb. 1, 2002 (DE) 102 04 313.2

(51) Int. Cl. B26D 3/00; B26D 7/20; B26D 7/02

(52) U.S. Cl. 83/54; 83/659; 83/451

(57) ABSTRACT

The invention relates to a process and a device for cutting label sleeves off from a flat tubular label belt, unfolding and attaching the tubular label sleeves to objects, whereby a flat label sleeve is, no later than immediately after the cutting off of the tubular label belt, grasped on one side, transported continuously away, in a regular manner, by a cutting device while likewise grasped on the opposite side for a short time, in a non-uniform manner relative to the other side, transported in the same direction, and is, after that, opened by means of a lateral expansion of distance of both of the flat sides.

### DESCRIPTION

The invention relates to a process and device for cutting label sleeves off from a flat tubular label belt, unfolding and attaching the tubular label sleeves to objects in accordance with the introductory portion of claim 1 or of claim 6, respectively.

Corresponding processes and devices are known from the European patent EP 0 805 110 B1 and the Japanese patent disclosure document JP-A-9-77032.

Upon cutting label sleeves off of a flat tubular label belt, the problem arises that the edges of a cut-off label sleeve positioned one above the other and proceeding forward in the direction of transport can frequently only be opened with difficulty. In order to facilitate the opening of the cut label sleeves, it is proposed, in EP 0 805 110 B1, to twist the lateral edges of the label sleeves by means of stationary turning plates projecting into the path of transport in such a manner that the cut edges on the leading end that are still clinging to one another after the cutting do detach.

In JP-A-9-77032, the problem is supposed to be eliminated through the fact that the cut label sleeves are conveyed, on a non-linear, approximately S-shaped transport path, to an unfolding device, whereby the non-linear transport path is supposed to detach the cut edges of the label sleeves that are adhering to one another.

The task which forms the basis for this invention is that of presenting a process and a device that should make an effective and operationally-secure detaching of the leading edge of label sleeves possible before the unfolding.

This task is solved, on the process side, by means of the characterizing features of claim 1 and, on the device side, by means of the characterizing features of claim 6.

By means of the short-term, continuously irregular movement of the one side of the still-flat label sleeves relative to the other side, which is moved in a regular manner, the cut edges adhering to one another can, under certain circumstances, be detached from one another, as the result of which the opening and complete unfolding into a tubular label sleeve is, in an advantageous manner, facilitated considerably.

On the device side, this is brought about by means of a continuously-drivable conveyor belt acting on one side of the flat label sleeve and a second conveyor, continuously drivable in a periodically irregular manner and acting on the other side, which [second conveyor] can be configured as a simple friction roller or belt, for example. A configuration in which a label sleeve is grasped, during the phase of the non-uniform transport movement, over approximately its entire length in a force-locking or frictionally-engaged manner, as the case may be, is particularly advantageous. A belt dimensioned to be correspondingly long can be provided for this purpose. It is, however, also conceivable to position several friction rollers one above the other.

If [the device] is, for the production of the periodically irregular movement, provided with its own electromechanical servo drive, then the amplitude, duration of period, phase position, and average conveyor speed can be very comfortably adjusted to different characteristics of the label (length, diameter, material, etc.) in connection with a programmable control, and the corresponding parameters can, in the event of a reconfiguration, be recalled from a memory store.

In an alternative manner, however, mechanical solutions for the production of the non-uniform movement are possible, such as by means of a crank-slide drive unit, for example, which can likewise be configured in an adjustable manner.

Further advantageous configurations are the object of the remaining sub-claims. One preferred example of implementation will be illustrated in the following by means of the figures. These depict:

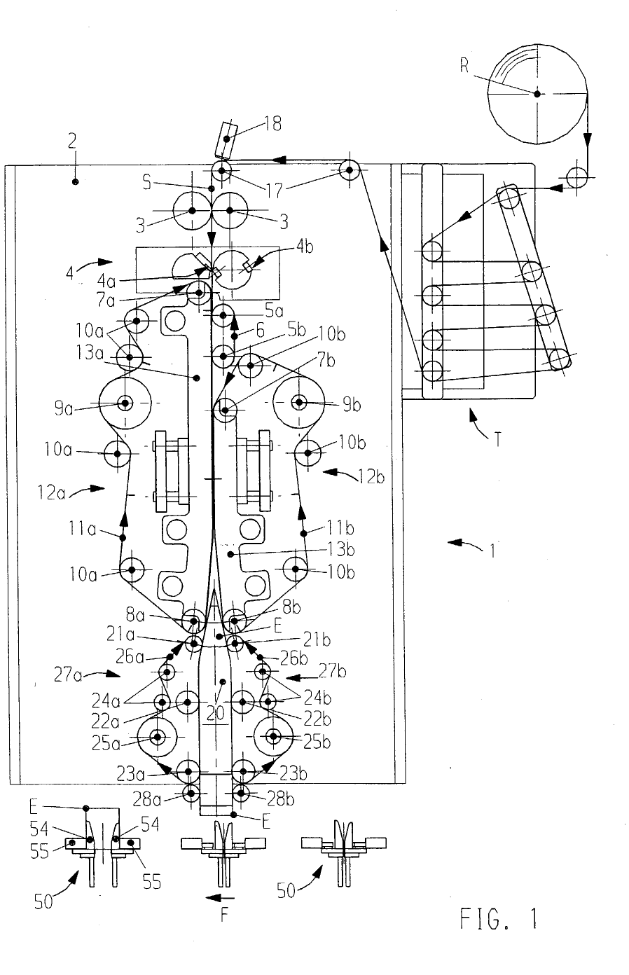

FIG. 1: A frontal view of an assembly for cutting label sleeves off from a flat label sleeve and unfolding the label sleeves;

FIG. 2: The speed gradient of the conveyor transporting the cut label sleeves from a cutting device to an unfolding device; and:

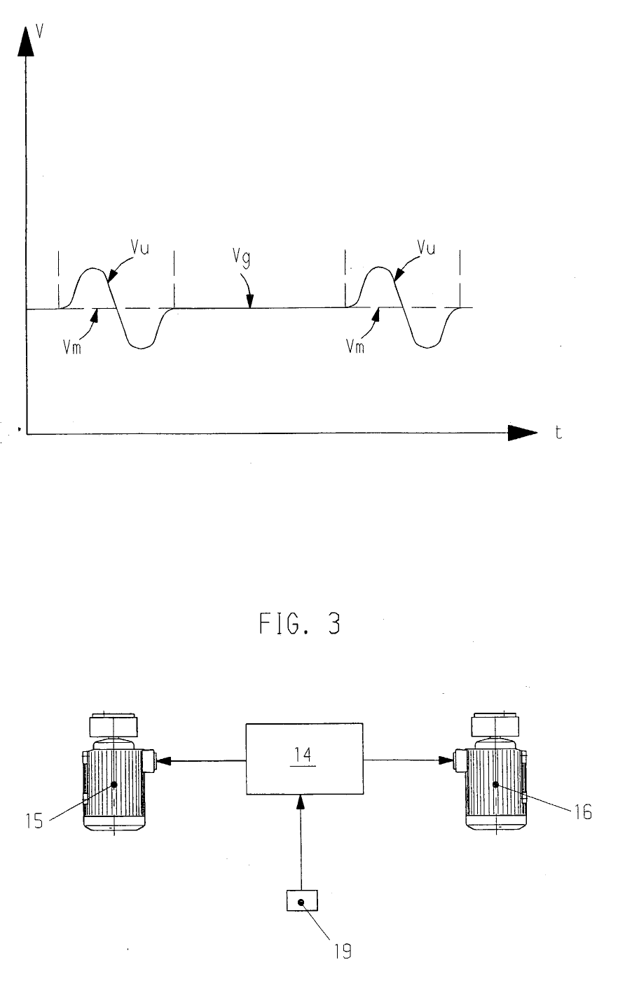

FIG. 3: A schematic depiction of the control and drive of the conveyor.

The device (1) has a vertically-oriented mounting plate (2), to the side of which a compensation roller unit (T) is positioned. On the front side of the mounting plate (2)—and considered in sequence from top to bottom—there are provided two deflecting rollers (17), a pair of forward feed rollers (3), a cutting mechanism (4)—consisting of a stationary blade (4a) and a cutting roller (4b) drivable in a rotating manner—, two conveyor belts (12a and 12b) underneath that, which are positioned opposite one another and operating together in the same direction, with the lower end area of which an unfolding mandrel (20), likewise with two conveyor belts (27a and 27b) placed opposite to its sides, is connected. Below these conveyor belts (27a and 27b), two acceleration rollers (28a and 28b) are located at the lower end of the unfolding mandrel (20).

The entire device (1) is positioned, in a height-adjustable manner, slightly above the horizontal circumferential plane of expanding wedge units (50) rotating on a closed track in the direction (F) of a machine for the placing of label sleeves (E) onto objects, such as bottles or the like. A corresponding machine is disclosed in detail in the international patent application WO 00/66437. An expanding wedge unit (50) has two arched half-shells (54), each oriented vertically upward, the curvature of which is adjusted to the external shape of the object to be labeled, such as a beverage bottle, for example. A pressure body (55) which can be moved forward and radially controlled from the outside, such as an elastic rubber buffer, for example, is coordinated with each half-shell (54). The construction and the function of this expanding wedge (50) is described in detail in the above-noted WO 00/66437.

The conveyor belt (12a) is essentially formed from a vertically-positioned vacuum casing (13a) and an endless flat belt (11a), which is vertically guided on the same in a sliding manner. The movement track of the perforated flat belt (11a) is determined by several deflecting- and tension rollers (10a), a drive wheel (9a), and two deflecting rollers (7a and 8a) attached to the vacuum casing (13a), whereby the upper deflecting roller (7a) is located immediately below the stationary blade (4a), while the lower deflecting roller (8a) reaches as far as the unfolding mandrel (20). The conveyor belt (12b) positioned diametrically opposite the conveyor belt (12a) likewise has a vertically-positioned vacuum casing (13b) and a flat belt (11b) guided thereon revolving vertically in a drivable manner, the circumferential track of which is determined by deflecting- and tension rollers (10b), and a driving roller (9b) and an upper deflecting roller (7b) supported rotatably on the vacuum casing (13b), as well as a lower deflecting roller (8b) in the area of the unfolding mandrel (20). In a manner different from the conveyor belt (12a), the conveyor belt (12b) is, however, configured in a shortened form, that is to say, the upper deflecting roller (7b) is located at some distance below the rotating cutting roller (4b), that is to say, positioned lower than the upper deflecting roller (7a) of the conveyor belt (12a), while the lower deflecting rollers (8a and 8b) are positioned at approximately the same height at a distance from one another. The vertical displacement between the two upper deflecting rollers (7a and 7b) amounts to a multiple of the length of the individual label sleeves (E).

A drivable friction element which, in the present example of implementation, is configured in the form of a friction belt (6) guided by means of a deflecting roller (5a) and a driving roller (5b), the strand of which [friction belt], oriented towards the flat belt (11a), is placed proceeding in parallel to this, is positioned in the free space between the rotating cutting roller (4b) and the upper deflecting roller (7b) of the conveyor belt (12b). This friction belt (6) preferably has a longitudinal extension corresponding approximately to the length of the individual label sleeve (axial distance [5a and 5b]). As can be inferred from FIG. 1, the two lower deflecting rollers (8a and 8b) of the conveyor belts (12a, 12b) have a mutual horizontal distance, and the lower end areas of the vacuum casing (13a, 13b) have a gradient of contour expanding laterally outwardly from the direction of transport of the label sleeve (E) and proceeding vertically downwardly, which [gradient] yields, in the direction towards the unfolding mandrel (20), a wedge space opening with a V-shape between the flat belts (11a and 11b), into which [space] the upper, wedge-shaped pointed end of the otherwise cylindrical unfolding mandrel (20) extends.

The two vacuum casings (13a, 13b) are each supported in an adjustable manner on horizontal guide units, so that their distance from each other, and thereby that of the flat belts (11a and 11b) as well, can be continuously adjusted in order to adapt to the characteristics (materials strength, etc.) of the label sleeves. The tension of the flat belt (11a or 11b, respectively) can thereby be adjusted by at least one of the deflecting rollers (10a or 10b, respectively).

The vertically-oriented unfolding mandrel (20) is held, in the known manner, by two tension rollers (22a and 22b) which are supported in a freely rotatable manner. Support rollers, which are not further discussed and which cooperate with the tension rollers, which [support rollers] determine the height position of the unfolding mandrel (20) but at the same time make possible the moving of label sleeves (E) by means of the conveyor belts (27a and 27b) acting on the opposite sides, however, are located in the unfolding mandrel (20). The conveyor belt (27a) has a flat belt (26a), which is guided vertically by means of an upper deflecting roller (21a) positioned immediately below the deflecting roller (8a), a lower deflecting roller (23a), a driving roller (25a), and deflecting- and tension rollers (24a) on a closed track. In precisely the same manner, the flat belt (26b) of the conveyor belt (27b) is guided in a symmetrical arrangement.

The lower end of the unfolding mandrel (20) projects vertically downwardly over the lower deflecting rollers (23a and 23b), whereby two acceleration rollers (28a and 28b) are positioned in this area immediately below the deflecting rollers (23a and 23b).

The forward feed rollers (3), the cutting mechanism (4), the conveyor belts (12a and 12b), the conveyor belts (27a and 27b), as well as the acceleration rollers (28) have their own electromechanical servo drives, not depicted in further detail in FIG. 1, which, by means of a common control unit (14) (FIG. 3), permit an operating sequence of the stated devices in a manner synchronous in speed and position.

In accordance with FIG. 3, the control (14) is connected with a rotation-imparting unit (19) positioned in the actual labeling machine, by means of which the control unit can control the servo drive (15) for the conveyor belts (12a, 12b, as well as 27a, 27b, if necessary) and the servo drive (16) for the friction belts (6) to be periodically driven in a non-uniform manner, precisely accurate in position in regard to the movement of the expanding wedge units (50) of the labeling machine serving as a control variable.

The function of the device (1) will be illustrated in the following:

A flat tubular belt (S) is removed from a label tube roller (R), transported, by means of a compensation roller (T) and deflecting roller (17), to the gap of the forward feed rollers (3) contacting each other, whereby the tubular belt passes a sensor (18) recognizing the printed pattern or invisible markings. The signals of the sensor make possible for the electrical servo drive of the forward feed rollers (3) a positionally-accurate transporting of the tubular label belt (S) to the cutting mechanism (4) in a manner corresponding to the printed pattern.

The tubular belt (S) introduced between the stationary blade (4a) and the rotating cutting roller (4b) moves, before the separation of a label sleeve (E) on one of its two flat sides, into placement with the vacuum-activated flat belt (11a) of the conveyor belt (12a). During this phase, there is some slippage on the flat belt (11a), which is driven faster in relation to the tubular belt, as the result of which the tubular belt (S) is, in an advantageous manner, continuously drawn tightly until the separation of a label sleeve (E). Immediately after the separating of the tubular belt (S), the cut-off label sleeve (E), which is still flat, can now follow the speed of the flat belt (11a), so that the label sleeve (E) is accelerated vertically downwardly, and is thereby brought onto the calibration dimension of the labeling machine. This calibration dimension can amount to a multiple of the length of the label sleeve (E).

As soon as a label sleeve (E) is located in the area between the flat belt (11a) and the friction belt (6), which acts on the opposite flat side of the label sleeve (E) in a frictionally-engaged manner, the electrical servo drive (16) of the friction belt (6) is driven by the time control, which has up to that time been synchronous in speed with the servo drive (15) of the flat belt (11a), in a diverging, short-term irregular manner, corresponding to the representation in FIG. 2, temporarily with increased and then with reduced speed (or vice versa) relative to the flat belt (11a), whereby a relative movement is carried out lengthwise to the vertical direction of transport of the label sleeve (E) between the two flat sides, with the result that the cut edges of the label sleeve (E) proceeding forward into the direction of transport are detached from one another, before the label sleeve (E) proceeds into the gap between the two flat belts (11a and 11b). The average speed (Vm) of the periodically non-uniform movement (Vu) corresponds to the continuously uniform speed (Vg) of the flat belt (11a), so that both of the cut edges of the label sleeve (E), which are positioned one on top of another after leaving the friction belt (6), are again located in a position parallel to one another. The sequence of movement depicted is periodically repeated with each newly cut-off label sleeve (E).

During the further process, the two flat sides of a cut label sleeve (E) are, upon the passage of the parallel-proceeding sections of the two vacuum casings (13a and 13b) through the perforation apertures present in the flat belts, suctioned onto the flat belts (11a and 11b). During the subsequent backwards movement of the label sleeve, this is continuously opened by the lower area, of the vacuum casings (13a and 13b) positioned opposite, which expand laterally in a V-shape, so that the tip of the unfolding mandrel (20) can penetrate into the aperture of the label sleeve (E) that arises. The label sleeve is, by means of the lower deflecting rollers (8a and 8b), pressed against the roof-shaped surfaces in the upper section of the unfolding mandrel (20) and displaced further vertically in the longitudinal direction until the label sleeve is, in the area of the upper deflecting rollers (21a or 21b, respectively), grasped by the next-following conveyor belt (27a and 27b) and thereby taken over.

These conveyor belts (27a and 27b), which are driven synchronously with the conveyor belts (12a and 12b) located above that, grasp the label sleeves in a frictionally-engaged manner and continuously displace them further backwards vertically through the unfolding mandrel (20), making a transition into a cylindrical shape in the area of the acceleration rollers (28a and 28b) positioned thereunder, which are, first of all, driven in a manner synchronous in speed with the flat belts (26a and 26b) for long enough until the next-following edge of the label sleeve is out of contact with the conveyor belts (27a and 27b). After that, the label sleeve (E), which is folded in a tubular manner, is accelerated vertically downwardly by the electromechanical servo drive of the acceleration rollers in order to slide the completely opened label sleeve (E), on an opened expanding wedge unit (50) horizontally proceeding, at the same moment, under the stationary unfolding mandrel (20), within the shortest time and in a precisely positioned manner. From the cutting until the complete unfolding of a label sleeve (E), this is moved on a continuous straight track.

1. A process and device for cutting label sleeves off from a flat tubular label belt, unfolding and attaching the tubular label sleeves to objects, characterized in that, a flat label sleeve is, no later than immediately after the cutting off of the tubular label belt, grasped on one side, transported continuously away, in a regular manner, by a cutting device while likewise grasped on the opposite side for a short time, in a non-uniform manner relative to the other side, transported in the same direction, and is, after that, opened by means of a lateral expansion of distance of both of the flat sides.

2. A process in accordance with claim 1, characterized in that, a label sleeve is, after the cutting off of the tubular label belt and up to the complete unfolding, transported on a linear, particularly a vertical, track.

3. A process in accordance with claim 1 or 2, characterized in that, the one side of the label sleeve is first of all accelerated relative to the other side and subsequently delayed or, in a contrary manner, moved continuously.

4. A process in accordance with one of the claims 1 to 3, characterized in that, both sides of a flat label sleeve have a leading cut edge which, immediately after the cutting, proceeds in parallel, during the continuous non-uniform movement of the one side of the label sleeve in the direction of transport in a reciprocally offset manner, and are, before the unfolding, oriented in parallel again.

5. A process in accordance with claim 4, characterized in that, the offset of the cut edges during the continuous non-uniform movement is changeable, particularly in dependence on the diameter and/or the length of the label sleeve.

6. A process for the cutting off of label sleeves (E) from a flat tubular label belt (S), unfolding and application of the tubular label sleeves onto objects, characterized in that, a flat label sleeve (E) is, in the area after a cutting mechanism (4), first of all grasped by a conveyor belt (12a) on one side, continuously transported away by this, in a uniform manner, from the cutting mechanism (4), during which the opposite side is grasped by an additional conveyor (6), which can be driven periodically in a non-uniform manner, transported in the same direction relative to the other side and is, after that, opened by a lateral expansion of distance of the at last one conveyor belt (12a, 12b).

7. A device in accordance with claim 6, characterized in that, the conveyor belt (12a) extends as far as directly up to the cutting mechanism (4) and the conveyor (6), which can be periodically driven in a non-uniform manner, is positioned opposite to the conveyor belt (12a), particularly at a distance from the cutting mechanism (4).

8. A device in accordance with claim 6 or 7, characterized in that, the conveyor belt (12a) is configured as a vacuum conveyor, and the conveyor (6) is configured as a friction conveyor.

9. A device in accordance with one of the claims 6 to 8, characterized in that, the conveyor (6) has a length approximately corresponding to the length of one label sleeve (E).

10. A device in accordance with one of the claims 6 to 9, characterized in that, the conveyor (6) is configured as a belt oriented approximately gap-free in parallel with the conveyor belt (12a).

11. A device in accordance with one of the claims 6 to 10, characterized in that, a second conveyor belt (12b), which is first of all configured proceeding in parallel to the first conveyor belt (12a) and, after that, with an increase of the lateral intermediate distance longitudinally to the direction of transport, is connected with the downstream end of the conveyor (6).

12. A device in accordance with one of the claims 6 to 11, characterized in that, the conveyor (6) can be continuously driven to a labeling machine, by means of an electromechanical servo drive (16) with a coordinated program control (14), in a periodically non-uniform manner, particularly synchronously in speed and position.
